(19) United States
(12) Patent Application Publication
(10) Pub. No.: US 2012/0186277 A1
(43) Pub. Date: Jul. 26, 2012

(54) APPARATUS AND METHOD FOR INSTALLATION BY UNLICENSED PERSONNEL OF A PRE-CHARGED, DUCTLES HEATING/COOLING SYSTEM

(75) Inventors: David J. Lingrey, San Antonio, TX (US); Charles Anthony Wheeler, JR., Universal City, TX (US); Kevin L. Eicher, Seguin, TX (US)

(73) Assignee: Friedrich Air Conditioning Co., a division of U.S. Natural Resources, Inc., San Antonio, TX (US)

(21) Appl. No.: 13/013,547

(22) Filed: Jan. 25, 2011

(51) Int. Cl. B23P 15/26; F25B 13/00

(52) U.S. Cl. 62/77; 62/324.6; 62/324.5

(57) ABSTRACT

A pre-charged heating/cooling system is shown for installation by unlicensed personnel. An outside unit includes an outside coil, outside fan, compressor and a reversing valve. An inside unit has an inside coil, inside fan for drawing air through the inside coil and discharging the conditioned air into the enclosed space, and a power cord connection. Electrical connections between the inside unit and the outside unit are secured in position by an electrical disconnect cover. A covering box covers both the electrical and refrigerant connections to the outside unit.

### BACKGROUND OF THE INVENTION

1. Technical Field

This invention relates to a heating/cooling system and, more particularly, to installation by unlicensed personnel of a pre-charged, ductless heating/cooling system.

2. Description of the Prior Art

Providing heat in the winter and cooling in the summer has been a concern to man since the earliest of recorded time. About one hundred years ago, electric energy came into common use as a means of providing air conditioning and heating. While initially air conditioning or heating was performed by separate devices, after a period of time, reverse cycling units were developed to provide heating, ventilation, and air conditioning, which systems were referred to as HVAC systems.

In a typical HVAC system, there is an indoor coil and an outdoor coil with an expansion valve and compressor located there between. A reversing valve is also included between the outdoor coil and the indoor coil so the system can be switched between cooling or heating. In the cooling cycle, the outdoor coil is the condenser and the indoor coil is the evaporator. In the heating cycle, the outdoor coil is the evaporator and the indoor coil is the condenser. Fans will move the air through both the indoor coil and the outdoor coil. If neither heating or cooling is necessary, the fan for the indoor unit can still provide air circulation within the enclosed space.

In a typical central HVAC unit, air is drawn through the indoor coil and flows into a duct system for delivery throughout the enclosed space. The ducts will have outlets that can be opened or closed as desired to provide the appropriate amount of conditioned air. The connection of the ducts from the indoor coil to the various rooms in the enclosed space to be heated or cooled has always required a lot of manpower and effort. In recent years, especially in countries having relaxed laws and regulations, there has been a trend to provide ductless HVAC systems. In the ductless systems, the refrigerant lines would run between the indoor and outdoor units, but there would not be ducts inside the conditioned space to deliver air from the indoor coil to the various rooms being conditioned. Instead, a fan would draw air through the indoor coil to be discharged directly into the room. If more than one room was to be conditioned, multiple indoor coils would be used. The multiple indoor coils could be connected in parallel so that each could act as an evaporator if cooling is necessary or a condenser if heating is necessary.

In the more developed countries that have codes and regulations covering how HVAC systems are to be wired and operated, electrical codes and regulations mandate the use of an electric disconnecting means for safety reasons. To put in the electrical connection requires a licensed electrician. Also, to charge an HVAC system with a refrigerant once it is installed requires another licensed individual. If a need for these licensed individuals can be eliminated while meeting necessary codes and regulations, then an HVAC system could be installed by unlicensed personnel.

### BRIEF SUMMARY OF THE INVENTION

It is an object of the present invention to provide a ductless HVAC system.

It is another object of the present invention to eliminate the need for licensed individuals when installing a ductless HVAC system.

It is another object of the present invention to provide a pre-packaged, pre-charged ductless HVAC system for installation by unlicensed personnel.

It is still another object of the present invention to provide a method and apparatus for connecting the outdoor unit of an HVAC system that would eliminate the need for licensed personnel but, instead, can be installed by unlicensed personnel.

A pre-packaged HVAC system is provided that has an outdoor unit complete with a mounting skid. The outdoor unit will include an outdoor coil, compressor and reversing valve. The outdoor unit will be pre-charged with a refrigerant and connects to a dual-refrigerant connector that is accessible under a covering box. Also under the covering box is a clamped-down male electrical connection. An electrical disconnect cover will clamp any connecting electrical cable in place. The electrical cable when clamped in place cannot accidentally fall down into water or any other substance to create a danger of electrocution of individuals working thereon.

The outdoor unit is shipped on a lightweight pad, which lightweight pad can then be used to mount the outdoor unit thereon outside of the conditioned space. The lightweight pad may rest directly on the ground or any other desired location by the user.

The inside unit has a mounting bracket that can be attached to the wall. The inside unit will have a cable sheath, which cable sheath will include inside thereof a pair of refrigerant lines and an electrical cable. A drainage line may or may not be included within the sheath, depending upon the desires of the end-user.

Typically, the indoor unit is mounted on the wall with a hole through the wall located immediately there behind. The mounting bracket is secured to the wall adjacent to the hole. The cable sheath is inserted through the hole and the indoor unit is secured to the mounting bracket. The pair of refrigerant lines would be connected to the dual-refrigerant connector on the outdoor unit. The electrical cable would be clamped down by the electrical disconnect cover. The female connector on the end of the electrical cable is connected to the male electrical connector inside of the electrical disconnect cover.

If filters have not already been inserted inside of the inside unit, filters are inserted. Thereafter, the inside unit is plugged in and turn ON, either with a switch thereon or with a remote control. The electrical connection from the inside unit connects through the electrical cable, the female connector, the male electrical connector to the outside unit. Because the electrical cable is clamped down by the electrical disconnect cover so that the electrical cable cannot fall into water or other fluids to cause electrocution or shock, and because the connection is contained within an electrical disconnect cover, the regulatory authorities will approve this unit acting as the factory installed disconnect.

The drain line may go all the way to the end of the cable sheath and drip any condensation on the ground, or the drain line could extend to any other location desired by the end user.

### BRIEF DESCRIPTION OF THE DRAWINGS

FIG. 1 is a pre-charged, ductless heating/cooling system for installation by unlicensed personnel.

FIG. 2 is a perspective view of the inside unit shown in FIG. 1 as installed in a ductless system.

FIG. 3 is a partial perspective view of the outside unit shown in FIG. 1 showing the refrigerant connection, electrical connection and drain of a ductless system.

FIG. 4 is a cross-sectional view of a wall of an enclosed space illustrating connections between the indoor unit and the outdoor unit of the ductless system shown in FIG. 1.

FIG. 5 is a perspective view illustrating the connection of the indoor unit and the outdoor unit of the ductless system shown in FIG. 1.

FIG. 6 is an outside perspective view of the electrical disconnect cover and cover door of a ductless system.

FIG. 7 is an inside perspective view of the electrical disconnect cover of ductless system.

FIG. 8 is a partial elevational view showing the electrical cable connection to the outdoor unit of the ductless system as shown in FIG. 1, but with the cover door removed.

### DESCRIPTION OF THE PREFERRED EMBODIMENT

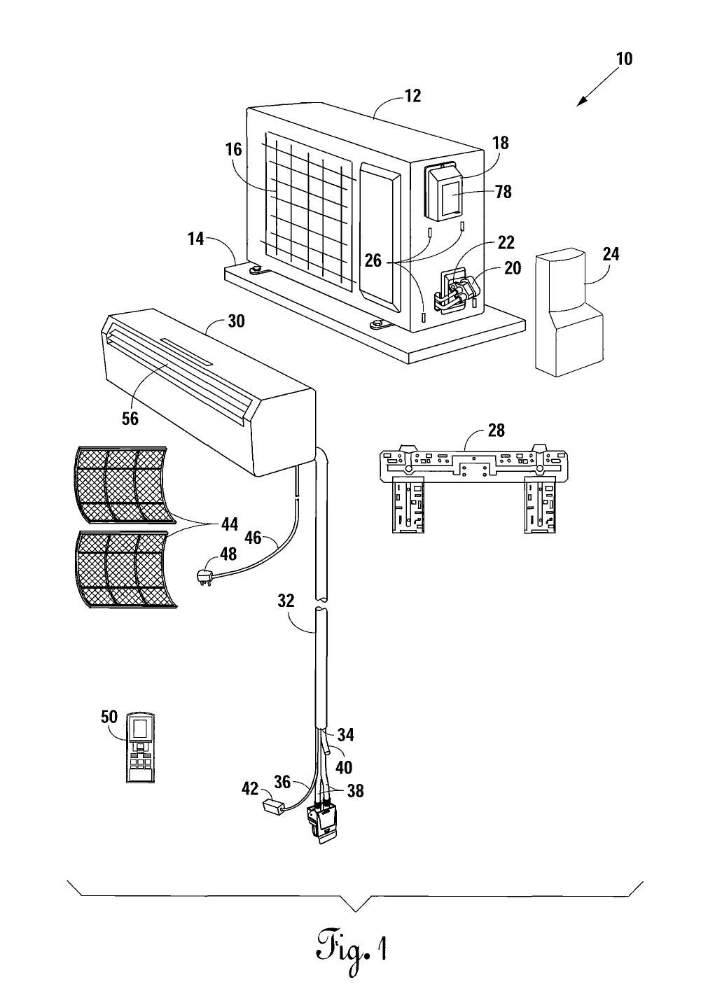

Referring now to FIG. 1, a perspective view is shown for a ductless heating/cooling system that can be installed by unlicensed personnel, which system is generally referred to by the reference numeral 10. The system 10 includes an outdoor unit 12 mounted on a lightweight pad 14. The lightweight pad 14 may be placed directly on the ground outside an enclosed space and used to support the outdoor unit 12. The lightweight pad 14 may also be used as support during shipment of the system 10.

Within the outdoor unit 12, behind the grill 16 is located the outdoor coil. The outdoor unit 12 includes a compressor (not shown) and/or a reversing valve (not shown). On one end of the outdoor unit 12 is mounted an electrical disconnect cover 18 and dual-refrigerant connector 20. Dual-refrigerant connector 20 is held in position by mounting bracket 22. The dual-refrigerant connector 20 is contained inside of covering box 24. Covering box 24 is held in position by tabs (not shown) inserted into slots 26.

The system also includes a mounting bracket 28 that is attached to the inside wall wherever the inside unit 30 is mounted. Extending from the back of the inside unit 30 is a cable sheath 32. A hole is cut in the wall directly behind the inside unit 30 to allow the cable sheath 32 to extend there through. Extending from the lower end 34 of the cable sheath 32 is the electrical cable 36, dual refrigerant lines 38 and drain line 40. Drain line 40 may or may not be included within the cable sheath 32, but in this preferred embodiment, the drain line 40 extends to the lower end 34 of the cable sheath 32. On the end of the electrical cable 36 is a female locking connector 42.

Inside the enclosed space (not shown in FIG. 1), if filters 44 have not been inserted into the inside unit 30, the filters 44 are inserted prior to use. Power cord 46 is plugged into any suitable outlet (not shown in FIG. 1) by electrical plug 48. A remote control 50 may then be used to turn ON the inside unit 30, which in turn supplies power via electrical cable 36 and female locking connector 42 to the outside unit 12.

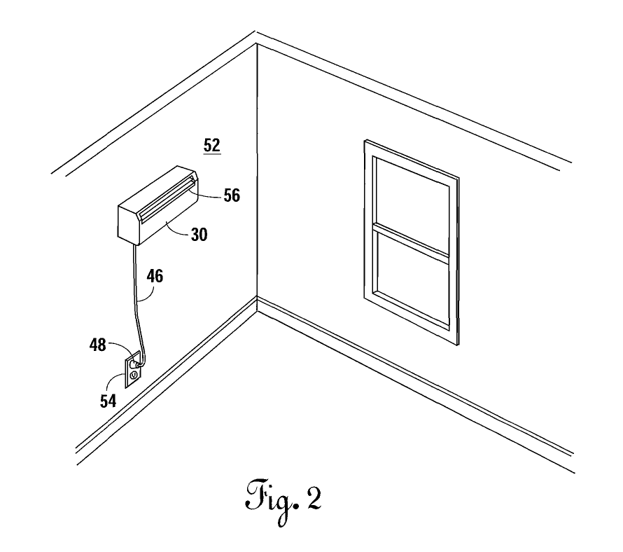

Referring now to FIG. 2, the typical mounting of the inside unit 30 on an inside wall 52 of an enclosed space is illustrated. The inside unit 30 is connected through power cord 46 and electrical plug 48 to wall outlet 54. Therefore, the wall outlet 54 is providing the power for not only the inside unit 30, but also the outside unit 12 (see FIG. 1).

In operation, a fan (not shown) will draw air up through the inside unit 30, which air is conditioned (either heated or cooled) and discharged into the enclosed space through inside louvers 56. Likewise, a fan (not shown) will draw air through the grill 16 of the outside unit 12, which air will subsequently be discharged to the atmosphere.

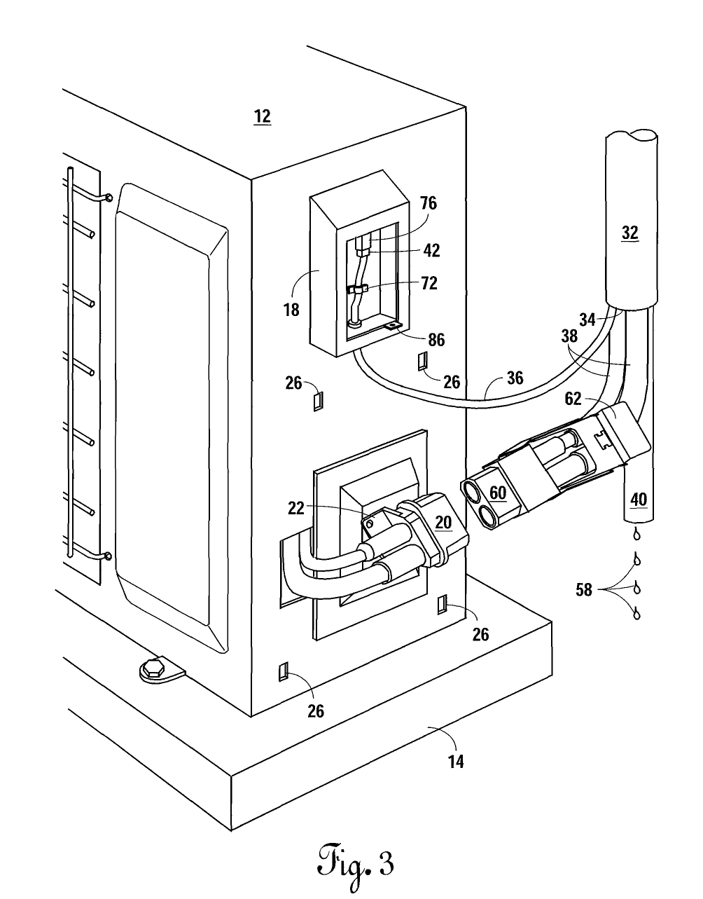

Referring now to FIG. 3, the end of the outside unit that has the connections thereto is shown, but with the covering box 24 removed. Extending out of the lower end 34 of the cable sheath 32 is the electrical cable 36, dual refrigerant lines 38 and drain line 40. While it may depend upon the environment, the drain line 40 may simply allow condensate to drip on the ground as illustrated by drops 58.

The dual-refrigerant connector 20, which is held in position by mounting bracket 22 connects to the dual-refrigerant line 38 by quick refrigerant connector 60. By use of the quick refrigerant connector 60 with the locking lever 62, the dual-refrigerant connector 20 can be connected to the dual refrigerant lines 38, even though both are fully charged.

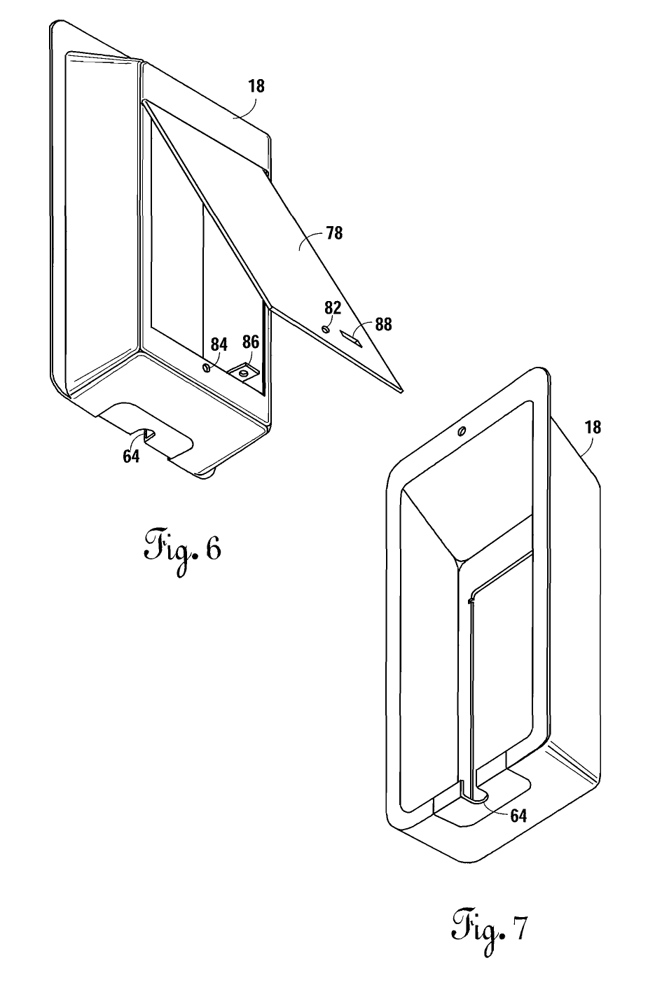

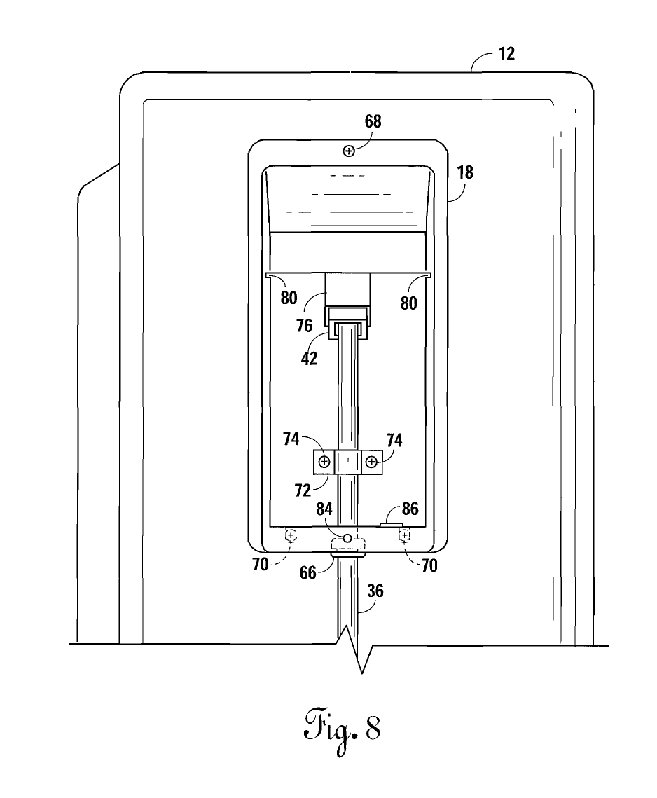

Referring now to FIG. 3 in combination with FIGS. 6, 7 and 8, the electrical disconnect cover 18 will be explained in more detail. The lower side of the electrical disconnect cover 18 has a mouse hole 64 therein. Formed integrally with the electrical cable 36 is a rubber grommet 66 that is secured inside of the mouse hole 64. When the electrical disconnect cover 18 is secured in position by screws 68 and 70 (see FIG. 8), the electrical cable 36 is held in place by the rubber grommet 66 being trapped in the mouse hole 64. Inside of the electrical connector cover 18, cable 36 is further held in position by clamp 72 being secured there across by screws 74. On the end of the electrical cable 36 is a female locking connector 42 that mates and locks with male locking connector 76.

After the electrical disconnect cover 18 has been secured in position, electrical cable 36 is clamped by rubber grommet 66 and clamp 72 and the female locking connector 42 mated with the male locking connector 76, the lid 78 may be secured on the electrical disconnect cover 18 (see FIG. 6). The lid 78 has an offset (not shown) that is received in slots 80 (see FIGS. 6 and 8). After the lid 78 is closed, it may secured by a screw (not shown) through screw holes 82 and 84. Tab 86 extends outward through slot 88 in the lid 78 to help ensure that the lid 78 stays in position.

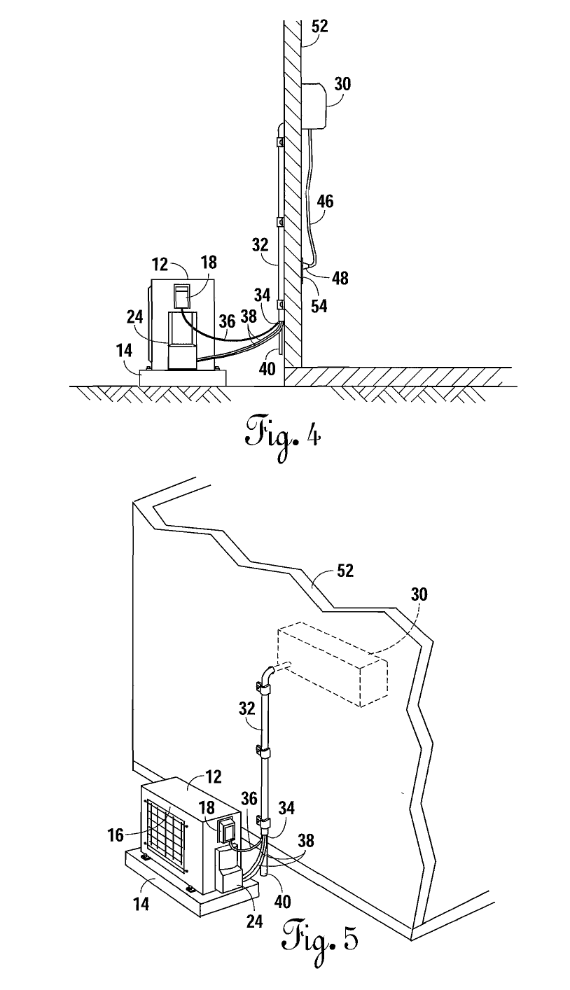

Referring now to FIGS. 4 and 5 in combination, a typical outdoor unit 12 is shown connected to indoor unit 30 through a cable sheath 32. Out of the lower end 34 of the cable sheath 32 extends dual-refrigerant lines 38, electrical cable 36 and drain line 40. The dual-refrigerant lines 38 connect to the outdoor unit 12 inside of the covering box 24. The covering box 24 helps protect the connections against the elements. The additional electrical disconnect cover 18 (not shown in FIGS. 4 and 5) provides additional insurance that the electrical connection will remain in place and not be a danger of shocking or electrocution.

While the preferred embodiment has shown the inside unit 30 to be mounted on the wall, the inside unit 30 could be anywhere that is convenient, including a stand-alone unit inside the enclosed space. The inside unit 30 could even be mounted in the ceiling. All that the unlicensed person would have to do to install the present system 10 is to cut a single hole of approximately 3 inches in diameter in the wall to extend the cable sheath there through. Immediately outside, the cable sheath can be clamped to the wall and connected to the outside unit. Since the outside unit 12 and inside unit 30 are both pre-charged, there is no need for refrigeration service personnel to come to charge the unit. Also because no electrical box is installed outside, no electrician is necessary to install the system 10. The only “construction” that would have to be done would be to cut the 3 inch hole in the wall for the cable sheath and mount the mounting bracket 28 on the wall 52. Thereafter, it is simply a matter of connecting the dual-refrigeration lines 38 and the electrical cable 36.

If the hole cut in the wall behind the inside unit 30 is too large, it may be weather-sealed with a rubber grommet there around or caulked with suitable caulking material.

While the present system 10 has been described as an HVAC system, it could be just air conditioning or just heating, depending upon the preference of the individual user.

Also, if the individual user desires to bring the drain line 40 out someway other than through the cable sheath 32, that also can be done. For example, the drain line could come straight out through the same hole as the cable sheath 32, but not be inside of cable sheath 32.

By use of the system as just described, a ductless HVAC system can be provided to as many indoor units 30 as are desired with indoor units 30 being located in different rooms. However, if indoor units 30 are connected in parallel, then a licensed refrigerant person might be necessary to recharge the system. However, for systems using a single indoor unit, recharging is not necessary.

Concerning the running of the cable sheath 32, the preferred embodiment shows the cable sheath 32 going through the wall 52 immediately behind the inside unit 30. The cable sheath 32 can go through the wall 52 at any desired location.

What we claim is:

1. A ductless, pre-charged HVAC system for installation by unlicensed personnel, said HVAC system to conditioning air within an enclosed spacing having walls there around, said HVAC system comprising:
a pre-charged outdoor unit secured to a lightweight pad, said outdoor unit including an outdoor coil, an outdoor fan for drawing outside air through said outdoor coil, a compressor and a reversing valve;
a pre-charged indoor unit including an indoor coil, an indoor fan for drawing inside air through said indoor unit and a filter for filtering the inside air;
a cable sheath for connecting said indoor unit to said outdoor unit through an opening in said wall, said cable sheath including dual refrigerant lines for supplying refrigerant between said indoor coil and said outdoor coil and an electrical cable for supplying power to said outdoor unit from said indoor unit;
power cord for connecting said indoor unit to an electrical outlet;
quick refrigerant connector between said dual refrigerant lines and said outdoor unit to allow refrigerant to flow back and forth between said outside unit and said inside unit;
electrical connector cover on said outdoor unit, said electrical connector cover receiving an electrical connector end of said electrical cable therein and holding said electrical connector end inside said electrical connector cover, said electrical connector end connecting to an outdoor power plug of said outdoor unit, said outdoor power plug being secured under said electrical connector over.

2. The ductless, pre-charged HVAC system as recited in claim 1 wherein said electrical connector cover has a lid to allow access to said electrical connector and said outdoor power plug.

3. The ductless, pre-charged HVAC system as recited in claim 2 wherein said holding of said electrical connector end is by a grommet and a clamp.

4. The ductless, pre-charged HVAC system as recited in claim 1 wherein said indoor unit has a drain line extending outside said enclosed space to dispose of condensate.

5. The ductless, pre-charged HVAC system as recited in claim 4 wherein said drain line extends through said opening inside said cable sheath.

6. The ductless, pre-charged HVAC system as recited in claim 1 wherein said system includes a mounting plate for mounting said indoor unit thereto on said wall.

7. The ductless, pre-charged HVAC system as recited in claim 6 wherein said opening in said wall is behind said indoor unit.

8. The ductless, pre-charged HVAC system as recited in claim 3 further including a removable covering box on said outdoor unit to help protect said quick refrigerant connector from adverse weather.

9. The ductless pre-charged HVAC system as recited in claim 8 wherein an outdoor refrigerant dual connector is mounted on said outdoor unit under said removable covering box, said outdoor refrigerant dual connector being removably connected to said quick refrigerant connector.

10. The ductless, pre-charged HVAC system as recited in claim 1 wherein said lightweight pad is used for shipping and when installed is a platform on which said outdoor unit rests.

11. A method of installation of a ductless, pre-charged HVAC system by unlicensed personnel to condition air of an enclosed space having walls there around, said method including the following steps:
selecting a location for an inside unit on said wall, said inside unit including an inside coil, inside fan for drawing inside air through said inside coil before discharging into said enclosed space and filters for filtering said inside air;
cutting a hole through said wall at said location, said hole being large enough to receive there through from said indoor unit an electrical cable, dual refrigerant lines and a drainage line;
mounting said indoor unit over said hole and simultaneously extending said electrical cable, dual refrigerant lines and said drainage line through said hole;
securing said outdoor unit to a lightweight shipping pad;
placing said outdoor unit and said lightweight shipping pad outside said enclosed space but near said hole;
first connecting outside dual ends of said dual refrigerant lines to a dual refrigerant connector mounted on said outdoor unit with a quick refrigerant connector;
second connecting an outside female end of said electrical cable to a male electrical connector mounted on said outdoor unit;
clamping said electrical cable near said outside female end to prevent said female end from reaching the ground when unplugged;
covering said outside dual ends of said refrigerant lines and said outside female end of said electrical cable when connected;
plugging said inside unit into an electrical outlet and turning the HVAC system ON.

12. The method of installation of a ductless, pre-charged HVAC by unlicensed personnel as recited in claim 11 wherein said covering step includes mounting covering boxes over refrigerant and electrical connections to said outside unit.

13. The method of installation of a ductless, pre-charged HVAC by unlicensed personnel as recited in claim 12 wherein said covering step further includes covering said electrical connection with an electrical disconnect cover attached to said outside unit, said electrical disconnect cover holding said electrical cable near said outside female end in position.

14. The method of installation of a ductless, pre-charged HVAC by unlicensed personnel as recited in claim 11 wherein said dual refrigerant lines and said electrical cable are retained inside a cable sheath that terminates adjacent said outside unit.

15. The method of installation of ductless, pre-charged HVAC by unlicensed personnel as recited in claim 14 wherein said drainage line is also inside said cable sheath, condensate from said drainage line dropping to the ground.

16. The method of installation of ductless, pre-charged HVAC by unlicensed personnel as recited in claim 15 includes an additional step of attaching a mounting plate near said hole, said mounting plate being used for said mounting step of said indoor unit.
